(19) United States
(12) Patent Application Publication
(10) Pub. No.: US 2005/0083857 A1
(43) Pub. Date: Apr. 21, 2005

(54) Communication environment setting method and communication environment setting program

(75) Inventors: Koji Takahashi, Hiratsuka-shi (JP); Yasushi Tsushimi, Hiratsuka-shi (JP); Tomoyasu Hamada, Hiratsuka-shi (JP); Jun Yamane, Hiratsuka-shi (JP); Kentarou Tajima, Hiratsuka-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KOMATSU LTD., Tokyo (JP)

(21) Appl. No.: 10/955,783

(22) Filed: Sep. 30, 2004

(30) Foreign Application Priority Data
Sep. 30, 2003 (JP) 2003-342066

(51) Int. Cl. H04L 12/28

(52) U.S. Cl. 370/254; 370/312; 370/390; 709/223

(57) ABSTRACT

When incorporating a print server (20) in a LAN (1), an attached communication environment setting program is installed in a client terminal (10) and executed. Thereby, an address-search packet is generated and broadcasted within the LAN (1). In the server (20), a previously stored program generates a response packet containing the own IP address, and broadcasts the response packet. In the client terminal (10), upon receiving the response packet, communication environment is set up based on the IP address contained in the response packet. Thus, only by installing the communication environment setting program in the client terminal (10) and executing the same, the communication environment between the client terminal (10) and the print server (20) can be readily and automatically set up.

### BACKGROUND OF THE INVENTION

1. Field of the Invention

The present invention relates to a communication environment setting method and a communication environment setting program between terminals connected to, for example, a LAN (Local Area Network).

2. Description of Related Art

In many families, recently, some family members respectively have personal computers (hereinafter, referred to as PC) of their own, and each of them uses the Internet. Such families may build a home LAN so as to communicate among the respective PCs. In such case, peripheral equipments such as printers, which are conventionally connected to one PC, are also incorporated in the LAN and shared among the PCs.

On the other hand, to share such printer with plural PCs, different from the case where one PC occupies the printer, a print server is necessary. As for the print server, a commercially available print server may be purchased and connected to the LAN. However, to transmit data from the PCs, the communication environment should be correctly set up by specifying the address of the print server in each PC, and so on.

Among various types of protocols available for computer network, TCP/IP (Transmission Control Protocol/Internet Protocol) is now used most widely, irrespective of connection to the Internet. Accordingly, as long as the TCP/IP is used, any terminal connected to the LAN is always assigned with an IP address. Also, when a print server is designated as a communicating party, the IP address of the print server should be specified in the PCs at the data transmitting end.

In some cases, the IP address has to be specified only once. However, in the case where the LAN is connected to the Internet via a router, and when the router has DHCP (Dynamic Host Configuration Protocol) function, there is a possibility that, every time when the system is started, the PCs and the print server may be automatically assigned with IP address different from the previous one (for example, Japanese Patent Laid-Open Publication No. Hei 10-271117, Paragraph No. 0013 to 0015, FIG. 5). Accordingly, the setting needs to be checked and, if necessary, configured again every time when the system is started.

However, especially when a LAN is built at home, an ordinary user with little knowledge has to specify the IP address referring to attached manual or the like and to set up the communication environment correctly, and such task might be a troublesome and time consuming for the user.

Particularly, in the case where a router or the like with the DHCP function is used, even when the setting has been completed, depending on which PC or peripheral equipment is started first, a totally different IP address may be assigned. In such case, the setting is required every time when the system is started.

### SUMMARY OF THE INVENTION

An object of the present invention is to provide a communication environment setting method and a communication environment setting program capable of setting the address of a communicating party with ease in the client terminal.

A communication environment setting method according to the present invention is adapted to set, for a client terminal connected to a computer network, an address of a server that communicates with the client terminal, the method including the steps of: in the client terminal, generating a search packet for searching an address; broadcasting the search packet; receiving a response packet containing the address of the server; and setting the address, and in the server, receiving the search packet; generating the response packet; and broadcasting the response packet.

A communication environment setting program according to the present invention is adapted to set, for a client terminal connected to a computer network, an address of a server that communicates with the client terminal, and the program makes the client terminal function as: a search packet generator that generates a search packet for searching an address; a broadcast transmitter that broadcasts the search packet; a response packet receiver that receives the response packet containing the address of the server; and an address setter that sets the address, while making the server function as: a search packet receiver that receives the search packet; a response packet generator that generates the response packet; and a broadcast transmitter that broadcasts the response packet.

### BRIEF DESCRIPTION OF THE DRAWINGS

FIG. 1 is a diagram schematically showing a computer network to which a communication environment setting method and a communication environment setting program in accordance with an embodiment of the present invention are applied;

FIG. 2 is a block diagram showing a client terminal;

FIG. 3 is a block diagram showing a server;

FIG. 4 is a diagram schematically showing a search packet and a response packet; and

FIG. 5 is a flowchart showing communication environment setting.

### DETAILED DESCRIPTION OF PREFERRED EMBODIMENTS

Now, an embodiment of the present invention will be described by referring to the drawings.

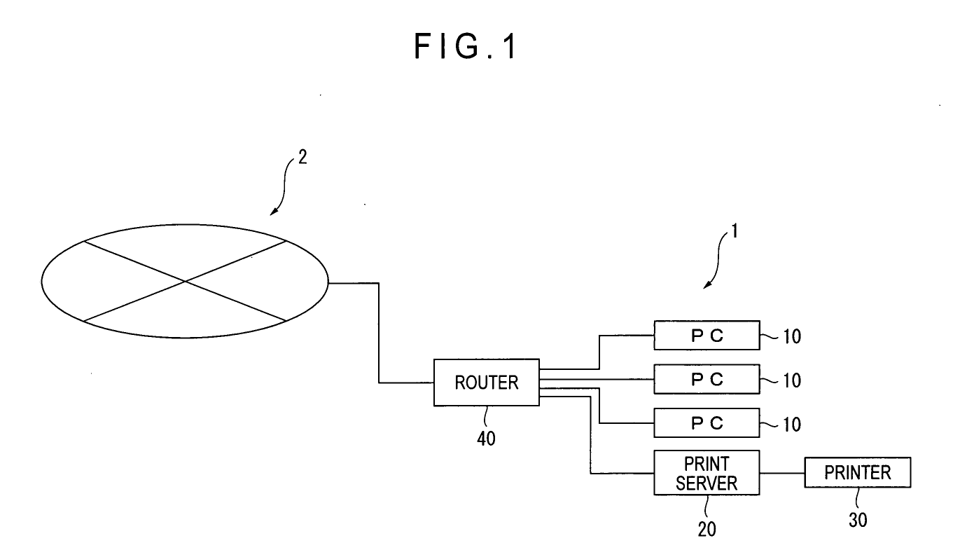

FIG. 1 is a diagram schematically showing a LAN (computer network) 1 to which a communication environment setting method and a communication environment setting program in accordance with this embodiment are applied.

The LAN 1 is a relatively small size network, which is built at home. The LAN 1 includes a plurality of PCs (three PCs in this embodiment) as client terminals 10, a printer 30 connected via a print server (server) 20, and a router 40 connected to each client terminal 10 and the print server 20. The LAN 1 is connected to the Internet 2 via the router 40.

In this embodiment, to share the printer 30, which is directly connected to one client terminal 10 when the network is initially built, with three client terminals 10 in the LAN 1, the printer 30 is connected to the router 40 via the print server 20 so that the print server 20 controls data transmitted from each client terminal 10 to print out the data. The present invention is used at the time of incorporating the newly purchased print server 20 in the network so as to automatically set up the communication environment in each client terminal 10 for enabling the communication between each client terminal 10 and the print server 20.

Although the LAN 1 uses the TCP/IP for its communication, the LAN 1 does not necessarily have to be connected to the Internet 2. If the LAN 1 is not connected to the Internet 2, a hub is used in place of the router 40. The printer 30 and the router 40, which are terminals connected to the LAN 1, have standard functions that are generally provided for these types of devices. Accordingly, detailed descriptions thereof will be omitted.

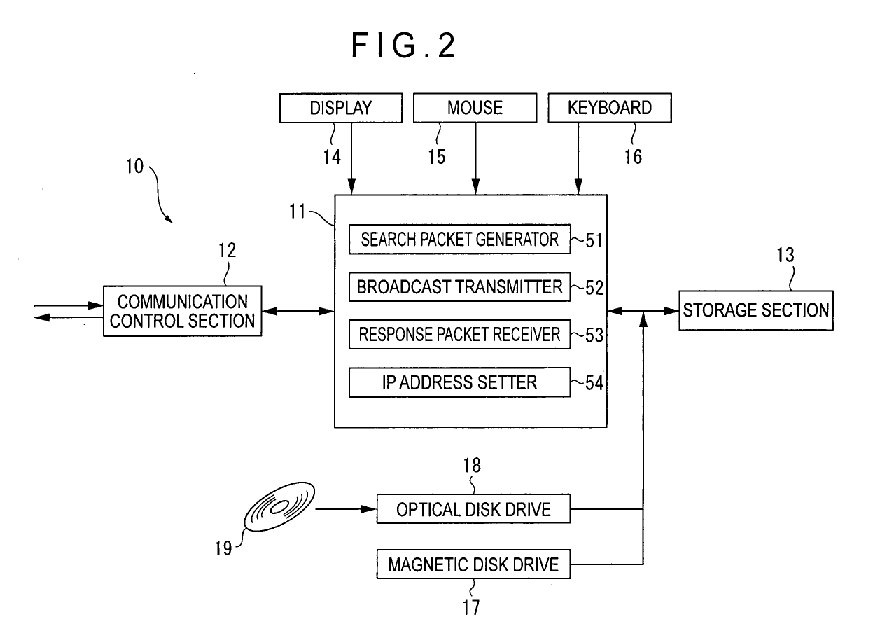

The client terminals 10 are basically general-purpose personal computers. As shown in FIG. 2, each client terminal 10 has an arithmetic processing section 11 for executing various utility programs (application software) that run on an OS (Operating System), a communication control section 12 for controlling data input/output via the LAN 1, a storage section 13 including a magnetic disk, a ROM, a RAM and the like, a display 14, a mouse 15, a keyboard 16, a magnetic disk drive 17, an optical disk drive 18 and the like. The client terminal 10 has an IP address, which is a fixed address or a dynamic address provided by the router 40, as well as own MAC (Media Access Control) address.

FIG. 2 shows a state that a CD-ROM 19 as a storage medium is inserted into the optical disk drive 18; an utility program (communication environment setting program) stored in the CD-ROM 19 is installed in the storage section 13; and the program is called up from the storage section 13 and executed in the arithmetic processing section 11. That is, FIG. 2 shows a state that, immediately after connecting the print server 20 to the LAN 1, a user sets up the communication environment using the CD-ROM 19 attached to the print server 20.

The utility program makes the client terminal 10 function as a search packet generator 51, a broadcast transmitter 52, a response packet receiver 53 and an IP address setter 54 so as to process a response packet received with a predetermined port number.

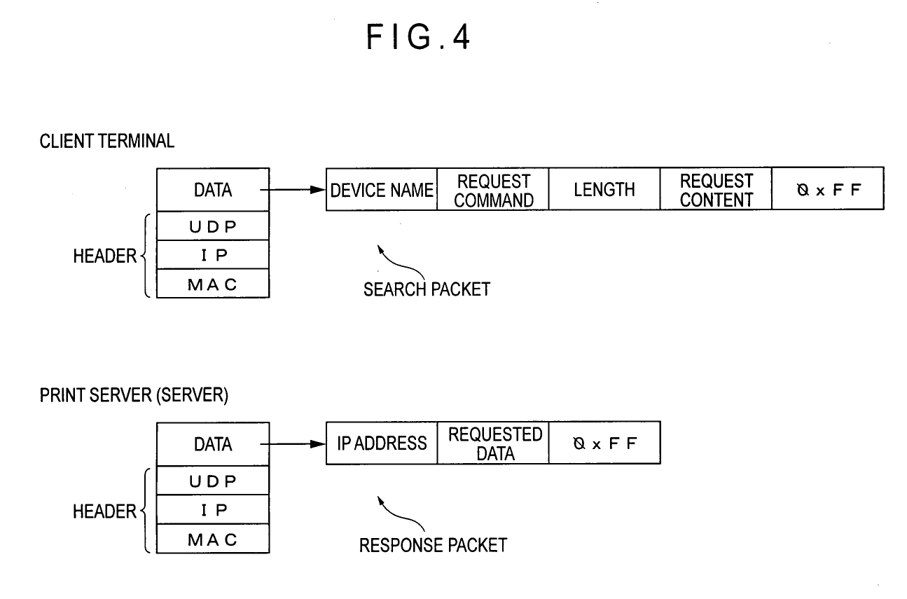

When the utility program is started, the search packet generator 51 generates a search packet for searching for IP address shown in FIG. 4 and sends the packet to the broadcast transmitter 52.

Referring to FIG. 4, the search packet carries a MAC address of the transmitting end (client terminal 10) and a MAC address of the receiving end (herein, MAC address for broadcasting) as the MAC header. As the IP header, an IP address of the transmitting end and an IP address of the receiving end (herein, IP address for broadcasting) are carried. As the UDP (User Datagram Protocol) header, a port number for processing the search packet using the program of the print server 20 (the same port number as the above-described port number for processing the response packet using the utility program) is carried.

As for the data structure of the search packet, a terminal name of the communicating party (herein, name of the print server 20), an IP address request command, data length, content of the request (the IP address of the communicating party, which is carried as “0” since it is unknown at this point) and end command (0 (zero)×FF) are carried.

The broadcast transmitter 52 broadcasts the search packet to all the terminals connected to the LAN 1 via the router 40, i.e., to other client terminals 10 and the print server 20.

The response packet receiver 53 receives a response packet (which will be described later) having a predetermined port number from a terminal (herein, the print server 20) connected to the LAN 1, and sends the packet to the IP address setter 54.

The IP address setter 54 sets the IP address carried by the response packet as the address of the communicating party utilizing a route command, which is generally provided to the client terminals 10.

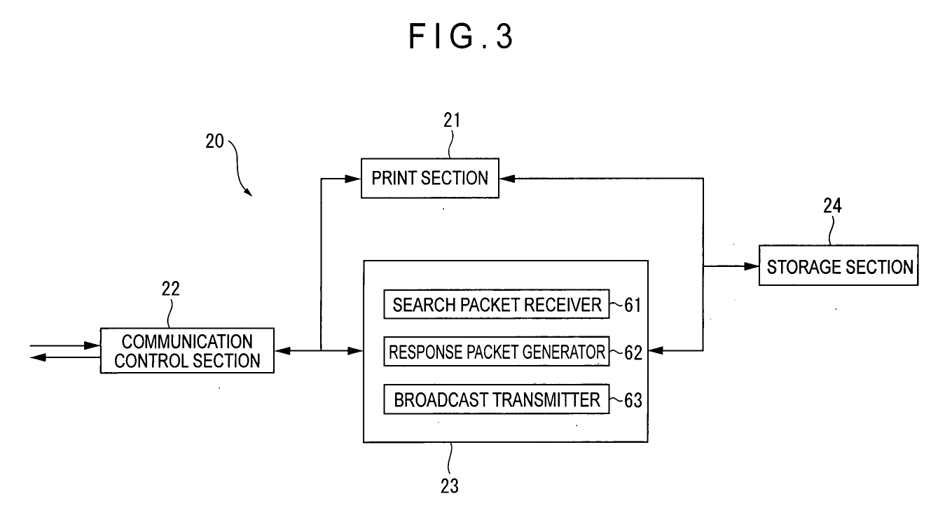

On the other hand, as shown in FIG. 3, the print server 20 has a print section 21 responsible for its original functions as the server, a communication control section 22 for controlling the data input/output via the LAN 1, an environment setting support section 23 for supporting the setting of the communication environment, and a storage section 24 including a ROM or the like. In the storage section 24, a search packet receiver 61, a response packet generator 62 and a broadcast transmitter 63 are stored as an environment setting program.

FIG. 3 shows a state that these functions 61 to 63 are called up and executed by the environment setting support section 23.

The search packet receiver 61 receives a search packet having a predetermined port number broadcasted in the LAN 1, and sends the packet to the response packet generator 62.

The response packet generator 62 generates a response packet containing the IP address of the print server 20 in accordance with the request command of the search packet, and sends the response packet to the broadcast transmitter 63.

Referring to FIG. 4, the response packet carries a MAC address of the transmitting end (print server 20) and a MAC address of the receiving end (herein, MAC address for broadcasting) as the MAC header. As the IP header, a factory setting IP address of the transmitting end and an IP address of the receiving end (herein, IP address for broadcasting) are carried. As the UDP (User Datagram Protocol) header, a port number for processing the response packet using the utility program of the client terminal 10 (the same port number as the port number for processing the search packet using the program of the print server 20) is carried.

As for the data structure of the response packet, the IP address of the print server 20 corresponding to the request command of the search packet, requested data (corresponding to the content of request of the search packet, which is also carried as “0”) and an end command (0 (zero)×FF) are carried.

The broadcast transmitter 63 broadcasts the response packet to all the terminals connected to the LAN 1 via the router 40, i.e., to all the client terminals 10.

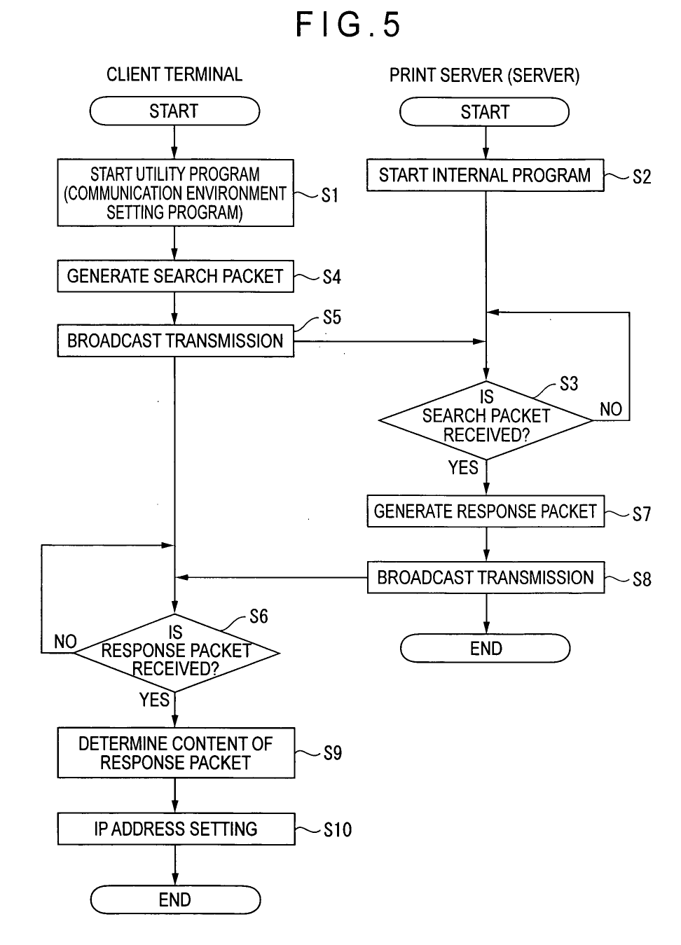

The following description will explain how to set the communication environment in the client terminal 10 when the print server 20 is newly connected to the LAN 1 with reference to the flowchart in FIG. 5.

Step 1 (hereinafter, the word “step” will be abbreviated to “S”): First of all, after connecting the print server 20 to the LAN 1, the CD-ROM 19 is inserted into the client terminal 10, and the utility program is installed and started.

S2, S3: Meanwhile, the print server 20 is turned on, and the search packet receiver 61 monitors the reception of a search packet.

S4-S6: In the client terminal 10, the search packet generator 51 generates a search packet, and the broadcast transmitter 52 broadcasts the search packet within the LAN 1. The response packet receiver 53 then monitors the reception of a response packet.

S7, S8: In the print server 20, when the search packet receiver 61 in S3 receives the search packet broadcasted by the client terminal 10, the response packet generator 62 generates a response packet containing the IP address of its own. The broadcast transmitter 63 then broadcasts the response packet within the LAN 1.

S9, S10: When the response packet receiver 53 of the client terminal 10 receives the response packet from the print server 20 and when it is determined that the response packet is the response from the MAC address of the print server 20, the IP address setter 54 recognizes that the IP address in the response packet is the address of the print server 20, and sets the IP address as the communicating party using the route command.

According to the above-described embodiment, the following effects can be obtained.

Owing to the communication environment setting program, an address-search packet is generated in the client terminal 10 and the search packet is broadcasted within the LAN 1. In the print server 20, the program previously stored therein receives the search packet, generates a response packet containing a factory-setting IP address or an IP address provided by the DHCP function of the router 40 or the like, and broadcasts the response packet. In the client terminal 10, on receiving the response packet, the communication environment is set up in accordance with the IP address contained in the packet. Accordingly, when the newly purchased print server 20 is incorporated in the LAN 1, it can be incorporated in the LAN 1 only by installing the utility program in the attached CD-ROM 19 in the client terminal 10 and executing the program. Thus, the communication environment between the client terminal 10 and the print server 20 can be automatically set up, thereby allowing an ordinary user with little knowledge carry out the setting operation with ease.

Further, even in the case where the address changes every time the client terminal 10 or the print server 20 is turned on due to the DHCP function of the router 40, by setting the client terminal 10 so that the utility program is automatically executed when the power is turned on, the user will not required to set the IP address manually again in the client terminal 10. Accordingly, the DHCP function can be effectively used without adverse effects.

The present invention is not limited to the above specific embodiment, but includes other configurations as long as the object of the present invention can be achieved. The following modifications are also included in the present invention.

For example, in the embodiment, the print server 20 is applied as the server according to the present invention. However, the server is not limited thereto, and may be a projector server, a FAX server, a router, a PC having various server functions or the like.

In the embodiment, since the protocol used in the LAN 1 is TCP/IP, the obtained address is the IP address. However, the address according to the present invention is not limited to the IP address, and may be determined in accordance with the protocol used in the computer network.

Although the preferred configuration of the network for carrying out the present invention, the data structure of the packet and the method of communication environment are described above, the present invention is not limited thereto. That is, while the present invention is described with reference to specific embodiments and drawing thereof, various modifications in shapes, materials, quantity and other configuration details may be made to the disclosed embodiments by those of ordinary skill in the art without departing from the spirit and scope of the invention.

Accordingly, the description limiting the shapes and the materials disclosed above is intended to be illustrative for easier understanding of the present invention and not intended to limit the invention. The present invention therefore includes descriptions of materials without all or a part of the limitation of the shapes and the material.

1. A communication environment setting method adapted to set, for a client terminal connected to a computer network, an address of a server that communicates with the client terminal, the method comprising the steps of:
in the client terminal,
generating a search packet for searching an address;
broadcasting the search packet;
receiving a response packet containing the address of the server; and
setting the address,
in the server,
receiving the search packet;
generating the response packet; and
broadcasting the response packet.

2. A communication environment setting program adapted to set, for a client terminal connected to a computer network, an address of a server that communicates with the client terminal, wherein
the client terminal is functioned as:
a search packet generator that generates a search packet for searching an address;
a broadcast transmitter that broadcasts the search packet;
a response packet receiver that receives the response packet containing the address of the server; and
an address setter that sets the address,
the server is functioned as:
a search packet receiver that receives the search packet;
a response packet generator that generates the response packet; and
a broadcast transmitter that broadcasts the response packet.
